(19) United States
(12) Patent Application Publication
(10) Pub. No.: US 2015/0151812 A1
(43) Pub. Date: Jun. 4, 2015

(54) BICYCLE CONTROL DEVICE

(71) Applicant: Shimano Inc., Osaka (JP)

(72) Inventor: Yoshimitsu MIKI, OSAKA (JP)

(73) Assignee: Shimano Inc., Osaka (JP)

(21) Appl. No.: 14/096,636

(22) Filed: Dec. 4, 2013

(51) Int. Cl. B62M 25/04

(52) U.S. Cl. CPC B62M 25/04

(57) ABSTRACT

A bicycle control device includes a base member, an operating member and a shifting unit. The base member is configured to be fixed to a bicycle part. The operating member is movably coupled relative to the base member, and is configured to perform a braking operation upon being moved along a braking path and to perform a shifting operation upon being moved along a shifting path differing from the braking path. The shifting unit is coupled to the base member, and is configured to be actuated in response to movement of the operating member along the shifting path, the shifting unit including a movable part at least partially disposed within the base member and a cable passageway extending through the movable part.

### BACKGROUND OF THE INVENTION

1. Field of the Invention

This invention generally relates to a bicycle control device. More specifically, the present invention relates to a bicycle control device that performs both shifting and braking operations.

2. Background Information

Generally, when riding a bicycle, it is desirable to be able to operate the brake control mechanism and the shift control mechanism of the bicycle quickly and easily while maintaining a firm grasp. Bicycle control devices have been developed that combine both the braking and shifting functions into a single unit. Examples of such control devices of this type are disclosed in the following U.S. Pat. Nos. 4,241,878; 5,257,683; 5,400,675; 6,073,730; and 6,212,078. For effecting braking and speed change, some of these known control devices have a brake lever that also acts as a shift lever that winds a wire take up member and a release lever located behind a brake/shift lever. While other known control devices have a shift lever that winds a wire take up member located behind a brake lever and a release lever that is located laterally of the brake lever. One example of a bicycle control device with a single brake/shift lever is disclosed in U.S. Patent Application Publication No. US2002/0139637 (assigned to Shimano, Inc.).

In view of the above, it will be apparent to those skilled in the art from this disclosure that there exists a need for an improved bicycle control device. This invention addresses this need in the art as well as other needs, which will become apparent to those skilled in the art from this disclosure.

### SUMMARY OF THE INVENTION

Generally, the present disclosure is directed to various features of a bicycle control device for actuating a bicycle component. One aspect is to provide a bicycle control device having a passageway extending through a shifting member that is capable of accepting a braking element. With this arrangement, a bicycle control device with an operating member that is simple to operate during braking and shifting operations can be provided.

Another object of the present invention is to provide a relatively compact bicycle control device that allows the rider to carry out braking and shifting operations.

Another object of the present invention is to provide a bicycle control device that is relatively simple and inexpensive to manufacture and assemble.

The foregoing objects can basically be attained in accordance with a first aspect of the present invention that provides a bicycle control device including a base member, an operating member and a shifting unit. The base member is configured to be fixed to a bicycle part. The operating member is movably coupled relative to the base member, and is configured to perform a braking operation upon being moved along a braking path and to perform a shifting operation upon being moved along a shifting path differing from the braking path. The shifting unit is coupled to the base member, and is configured to be actuated in response to movement of the operating member along the shifting path, the shifting unit including a movable part at least partially disposed within the base member and a cable passageway extending through the movable part.

In accordance with a second aspect of the present invention, the bicycle control device of the first aspect according to the first aspect is configured so that the movable part of the shifting unit includes a wire take up member configured to rotate about a rotational axis, and the cable passageway extends along a passage axis coaxial with the rotational axis.

In accordance with a third aspect of the present invention, the bicycle control device of the second aspect is configured so that the movable part of the shifting unit further includes a ratchet wheel fixed to the wire take up member so as to rotate together with the wire take up member about the rotational axis.

In accordance with a fourth aspect of the present invention, the bicycle control device of the first aspect is configured so that the operating member is configured to be moved along the shifting path from a rest position to a first shift position to actuate the shifting unit, and configured to be moved along the shifting path from the rest position to a second shift position to actuate the shifting unit, the first shift position being farther from the rest position than the second shift position.

In accordance with a fifth aspect of the present invention, the bicycle control device of the fourth aspect is configured so that the movable part of the shifting unit includes a wire take up member configured to rotate about a rotational axis in a first direction and a second direction being opposite to the first direction, the shifting unit being configured to rotate the wire take up member in the first direction as the operating member is moved from the rest position to the first shift position and being configured to rotate wire take up member in the second direction as the operating member is moved from the rest position to the second shift position.

In accordance with a sixth aspect of the present invention, the bicycle control device of the first aspect is configured so that the cable passageway is configured to receive an outer casing of a Bowden cable.

In accordance with a seventh aspect of the present invention, the bicycle control device of the first aspect is configured so that the operating member includes a receiving portion for receiving an end portion of a brake cable which passes through cable passageway of the shifting unit.

In accordance with an eighth aspect of the present invention, the bicycle control device of the first aspect is configured so that the operating member is pivotally attached to the shifting unit to pivot about a brake axis to perform the braking operation upon being moved along the braking path, the operating member is further pivotally mounted to the shifting unit to pivot about a shift axis to perform the shifting operation upon being moved along the shifting path.

In accordance with a ninth aspect of the present invention, the bicycle control device of the eighth aspect is configured so that the movable part of the shifting unit includes a wire take up member configured to rotate about a rotational axis, and the cable passageway extends along a passage axis coaxial with the rotational axis and the shift axis.

In accordance with a tenth aspect of the present invention, a bicycle control device comprises a base member, an operating member and a shifting unit. The base member is configured to be fixed to a bicycle part. The operating member is movably coupled relative to the base member to perform a braking operation upon being moved along a braking path. The shifting unit is coupled to the base member, the shifting unit including a movable part disposed on the base member and a cable passageway extending through the movable part, and being configured so as to receive an outer casing of a Bowden cable.

In accordance with an eleventh aspect of the present invention, a bicycle control device comprises a base member, an operating member, a shifting unit and a hydraulic braking unit. The base member includes a bicycle mounting structure and a gripping portion configured to be gripped by a rider. The operating member is movably coupled relative to the base member to perform a braking operation upon being moved along a braking path. The shifting unit is coupled to the base member, the shifting unit including a movable part and a passageway extending through the movable part. The hydraulic braking unit is at least partially disposed inside the passageway of the shifting unit.

In accordance with a twelfth aspect of the present invention, the bicycle control device of the tenth aspect is configured so that the movable part of the shifting unit includes a wire take up member configured to rotate about a rotational axis, and the passageway extends along a passage axis coaxial with the rotational axis.

In accordance with a thirteenth aspect of the present invention, the bicycle control device of the twelfth aspect is configured so that the hydraulic braking unit includes a cylinder body extending along a cylinder axis, a piston movably disposed in the cylinder body and a connecting rod connecting the operating member to the piston.

In accordance with a fourteenth aspect of the present invention, the bicycle control device of the thirteenth aspect is configured so that the cylinder axis is coaxial with the rotational axis and the passage axis.

In accordance with a fifteenth aspect of the present invention, the bicycle control device of the twelfth aspect is configured so that the movable part of the shifting unit further includes a ratchet wheel fixed to the wire take up member so as to rotate together with the wire take up member about the rotational axis.

In accordance with a sixteenth aspect of the present invention, the bicycle control device of the eleventh aspect is configured so that the operating member is configured to be moved along a shifting path from a rest position to a first shift position to actuate the shifting unit, and configured to be moved along the shifting path from the rest position to a second shift position to actuate the shifting unit, the first shift position being farther from the rest position than the second shift position.

In accordance with a seventeenth aspect of the present invention, the bicycle control device of the sixteenth aspect is configured so that the movable part of the shifting unit includes a wire take up member configured to rotate about a rotational axis in a first direction and a second direction opposite to the first direction, and the shifting unit being configured to rotate the wire take up member in the first direction as the operating member is moved from the rest position to the first shift position and being configured to rotate wire take up member in the second direction as the operating member is moved from the rest position to the second shift position.

In accordance with an eighteenth aspect of the present invention, the bicycle control device of the eleventh aspect is configured so that the operating member is pivotally attached to the shifting unit to pivot about a brake axis to perform the braking operation upon being moved along the braking path, the operating member being further pivotally mounted to the shifting unit to pivot about a shift axis to perform the shifting operation upon being moved along a shifting path which differs from the braking path.

In accordance with a nineteenth aspect of the present invention, the bicycle control device of the eighteenth aspect is configured so that the movable part of the shifting unit includes a wire take up member configured to rotate about a rotational axis, and the passageway extends along a passage axis coaxial with the rotational axis and the shift axis.

In accordance with a twentieth aspect of the present invention, a bicycle control device includes a base member, a first operating member, a shifting nit and a second operating member. The base member is configured to be fixed to a bicycle part. The first operating member is movably coupled relative to the base member, and configured to perform a braking operation upon being moved along a braking path. The shifting unit is coupled to the base member, the shifting unit including a movable part at least partially disposed within the base member and a cable passageway extending through the movable part. The a second operating member is movably coupled relative to the base member along a shifting path differing from the braking path, the second operating member configured to be moved along the shifting path from a rest position to a first shift position to actuate the shifting unit, and configured to be moved along the shifting path from the rest position to a second shift position to actuate the shifting unit, the first shift position being farther from the rest position than the second shift position.

In accordance with a twenty-first aspect of the present invention, the bicycle control device of the twentieth aspect is configured so that the movable part of the shifting unit includes a wire take up member configured to rotate about a rotational axis in a first direction and a second direction opposite to the first direction, and the shifting unit is configured to rotate the wire take up member in the first direction as the operating member is moved from the rest position to the first shift position and is configured to rotate wire take up member in the second direction as the operating member is moved from the rest position to the second shift position.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side view of a bicycle control device in accordance with one embodiment of the present invention;

FIG. 2 is a side view of the bicycle control device of FIG. 1 showing the operating member actuated along a braking path;

FIG. 3 is a front view of the bicycle control device of FIG. 1 showing the operating member actuated along a shifting path;

FIG. 4 is a side view of the bicycle control device of FIG. 1 showing the operating member actuated along the shifting path;

FIG. 5 is a partial cross-sectional view of the bicycle control device of FIG. 1;

FIGS. 6a-6f are cross-sectional views of a holding mechanism and a drive mechanism at different stages of a cable-release operation;

FIGS. 7a-7h are cross-sectional views of the holding mechanism and the drive mechanism at different stages of a cable-pull operation;

FIG. 8 is a side view of a bicycle control device in accordance with another embodiment of the present invention;

FIG. 9 is a side view of the bicycle control device of FIG. 8 showing the operating member actuated along a braking path;

FIG. 10 is a partial cross-sectional view of the bicycle control device of FIG. 8;

FIG. 11 is a partial cross-sectional view of the bicycle control device of FIG. 8 showing the operating member actuated along the braking path;

FIG. 12 is a side view of the bicycle control device of FIG. 8 showing the operating member actuated along a shifting path;

FIG. 13 is enlarged cross-sectional view of the piston in the bicycle control device of FIG. 8;

FIG. 14 is a side view of a bicycle control device in accordance with another embodiment of the present invention;

FIG. 15 is a side view of the bicycle control device of FIG. 14 showing the first operating member actuated in a braking path;

FIG. 16 is a front view of the bicycle control device of FIG. 14 showing the second operating member actuated in a shifting path; and

FIG. 17 is a side view of the bicycle control device of FIG. 14 showing the second operating member actuated in the shifting path.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

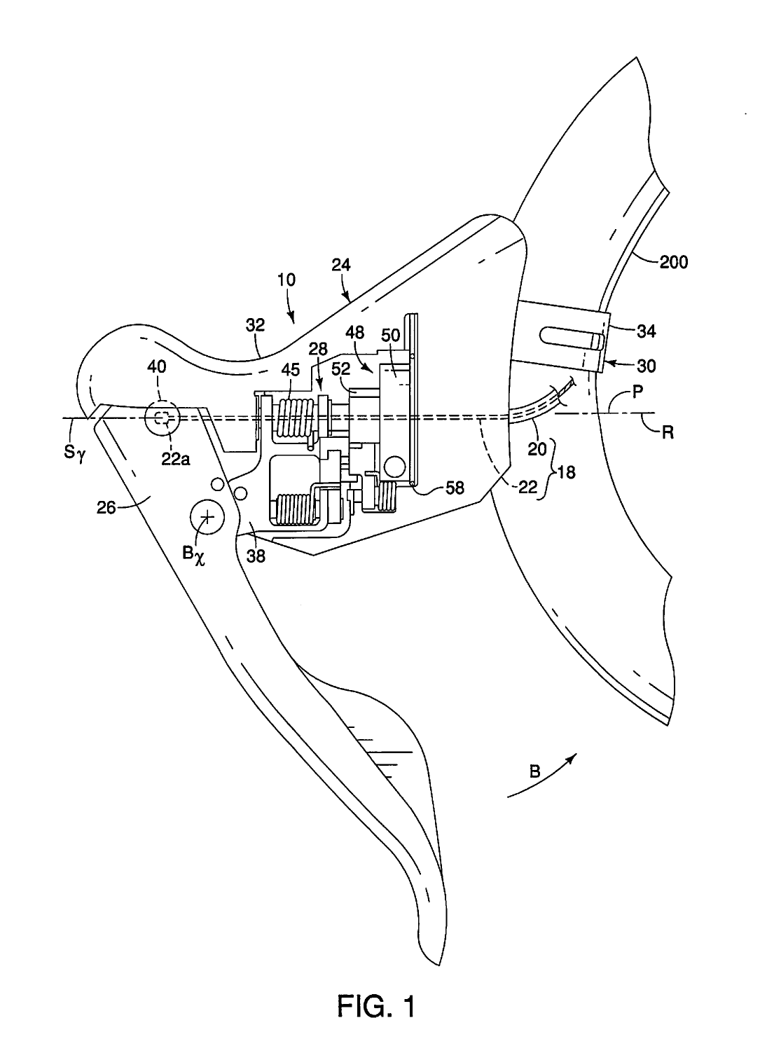

Referring initially to FIG. 1, a bicycle control device 10 in accordance with a first embodiment of the present invention is illustrated. In FIG. 1, the bicycle control device 10 is mounted on a handlebar 200. The handlebar 200 is a drop down handlebar for a road racer type bicycle. The bicycle control device 10 is a right hand control device that is operated by a rider's right hand to operate a brake device (not shown) and a transmission device (not shown). Although the bicycle control device 10 is the right hand control device, as one of ordinary skill in the art would understand, the invention can be applied to a left hand control device.

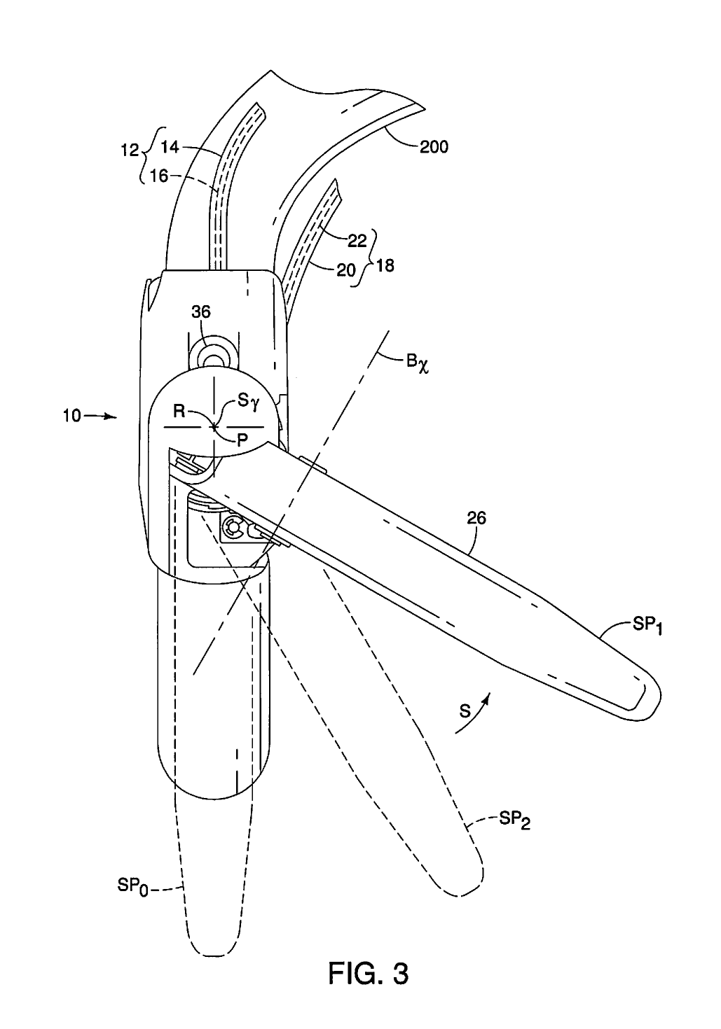

The bicycle control device 10 is operatively coupled to the transmission device (e.g., a derailleur or an internal hub gear) via a shift cable 12 (FIG. 3). The shift cable 12 is a conventional Bowden cable including an outer casing 14 and an inner cable 16. Further, the bicycle control device 10 is operatively coupled to the brake device (e.g., rim brake) via a brake cable 18. The brake cable 18 is a conventional Bowden cable including an outer casing 20 and an inner cable 22.

As shown in FIGS. 1-5, the bicycle control device 10 (i.e., the brake and shift operation device) comprises a base or fixing member 24, an operating member 26 and a shifting unit 28. The base member 24 may include a bicycle mounting structure 30 and a gripping portion 32 configured to be gripped by the rider. For example, the base member 24 may be a housing that is configured to be fixed to a bicycle part, such as the handlebar 200 by the bicycle mounting structure 30 including a clamp 34 (FIG. 1) and a bolt 36 (FIG. 3).

The operating member 26 is movably coupled relative to the base member 24, and is configured to perform a braking operation upon being moved along a braking path B and to perform a shifting operation upon being moved along a shifting path S (FIG. 3) differing from the braking path B. As illustrated in FIGS. 1-4, the operating member 26 is rotatably or pivotally attached to a bracket 38 of the shifting unit 28 to pivot about a brake axis Bₓ to perform the braking operation upon being moved along the braking path B. The bracket 38 is configured to pivot about a shifting axis S_{y}. Thus, the operating member 26 attached to the bracket 38 is further pivotally mounted to the shifting unit 28 to pivot about the shift axis S_{y} to perform the shifting operation upon being moved along a shifting path S which differs from the braking path B. In the present embodiment, the brake axis Bₓ is substantially perpendicular to the shift axis S_{y}.

The operating member 26 includes a receiving portion 40 for receiving an end portion 22a of the inner cable 22, which passes through a cable passageway 42 of the shifting unit 28. The other end of the inner cable 22 is attached to the brake device (not shown), as discussed above. The inner cable 22 is slidably received in the outer casing 20. The cable passageway 42 of the shifting unit 28 is configured to receive the outer casing 20 of the brake cable 18.

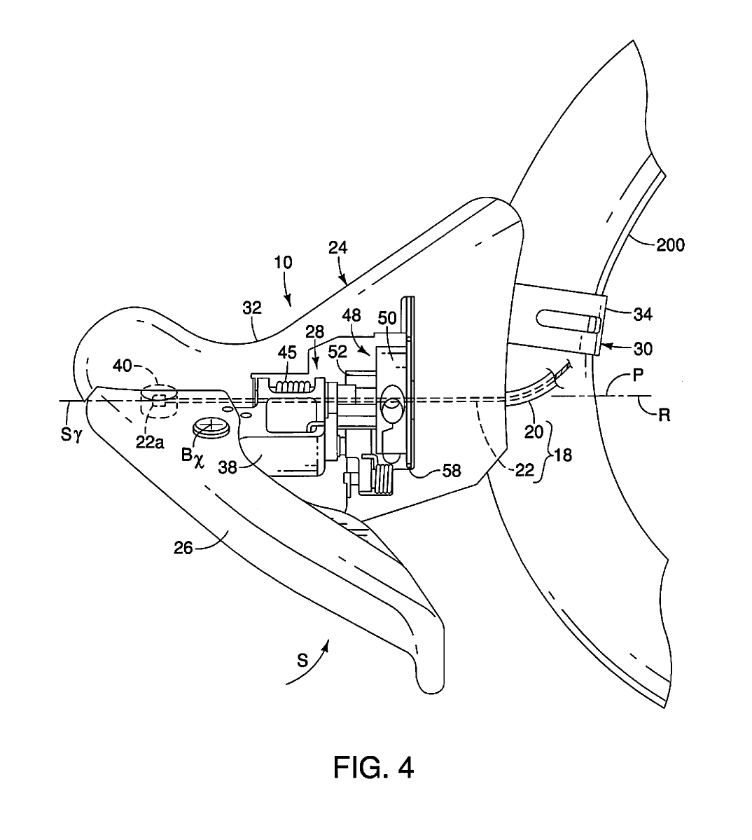

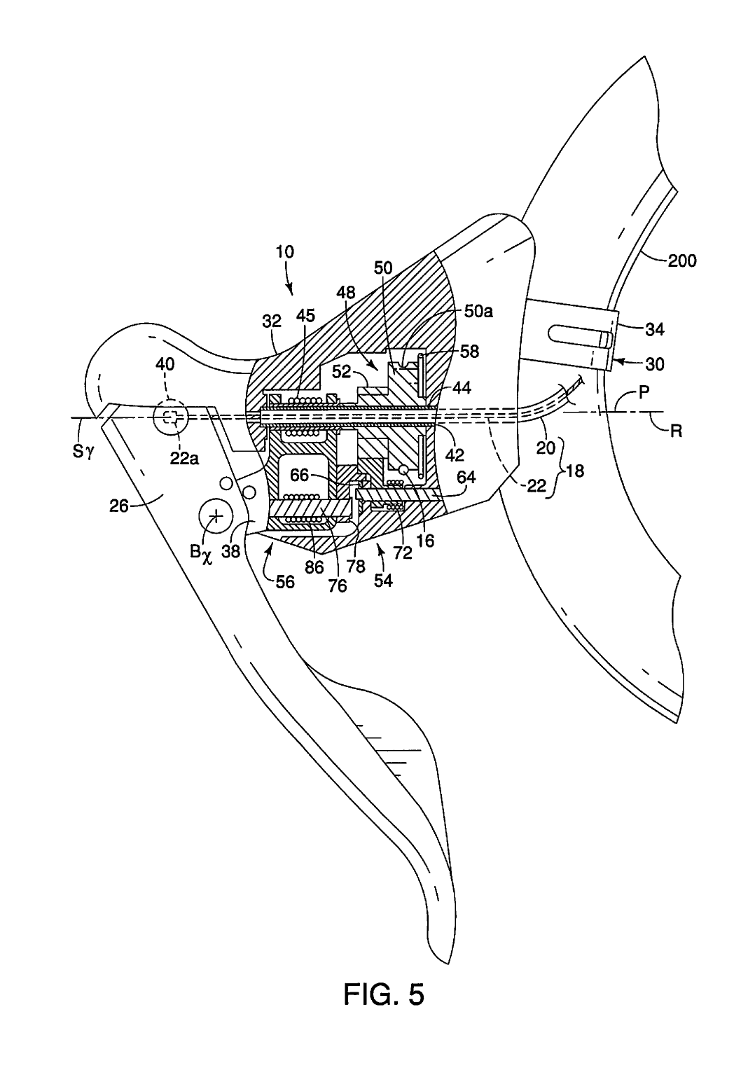

As shown in FIG. 5, in one embodiment, the outer casing 20 passes through a hollow cable receiving shaft 44. In other words, the cable passageway 42 is formed in the hollow cable receiving shaft 44. The hollow cable receiving shaft 44 is attached to the base member 24. A return spring 45 is disposed around the hollow cable receiving shaft 44. The return spring 45 biases the bracket 38 so as to position the operating member 26 at a rest position (FIG. 1) with respect to the shifting path S (FIGS. 3 and 4). Further, the operating member is biased by a return spring (not shown) to position the operating member 26 at the rest position (FIG. 1) with respect to the braking path B. The brake cable 18 exits the base member 24 such that the outer casing 20 contacts the handlebar 200, allowing the outer casing 20 to be easily taped to the handlebar 200.

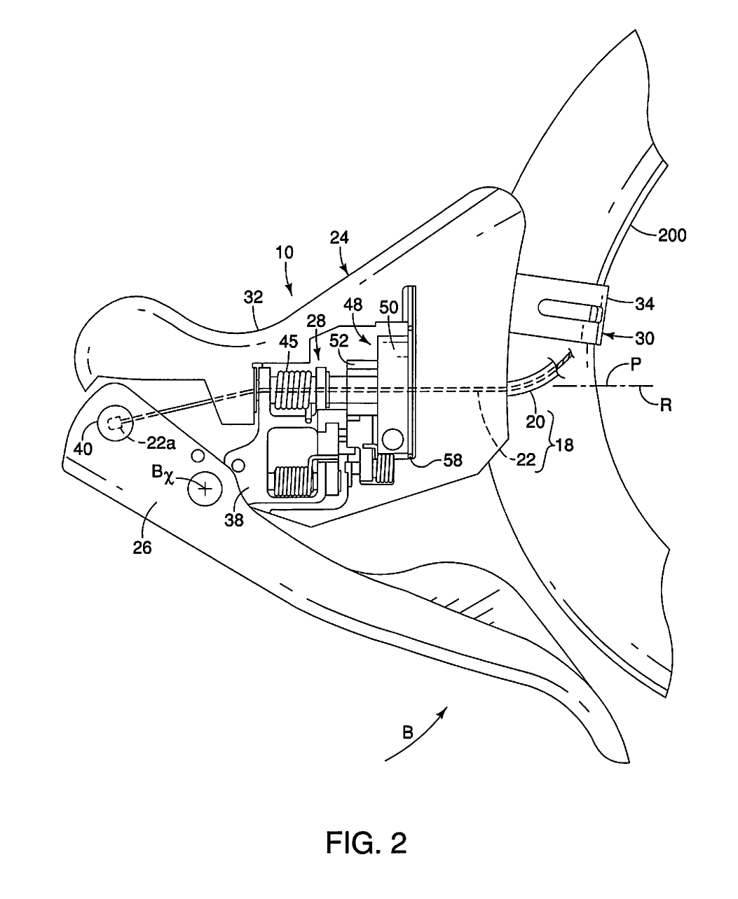

As shown in FIG. 2, when the operating member 26 is pivoted or rotated around the brake axis Bₓ along the braking path B toward the handlebar 200, the inner cable 22 of the brake cable 18 is pulled by the operating member 26.

As shown in FIGS. 1 and 5, the shifting unit 28 is coupled to the base member 24, and is configured to be actuated in response to movement of the operating member 26 along the shifting path S (FIGS. 3 and 4). As shown in FIGS. 1, 3 and 4, when the operating member 26 is pivoted or rotated along the shifting path S, this movement actuates the shifting unit 28 to pull or release the inner cable 16 of the shift cable 12 connected to the transmission device (not shown) to change gear speed. The shifting unit 28 generally includes a movable part 48 at least partially disposed within the base member 24.

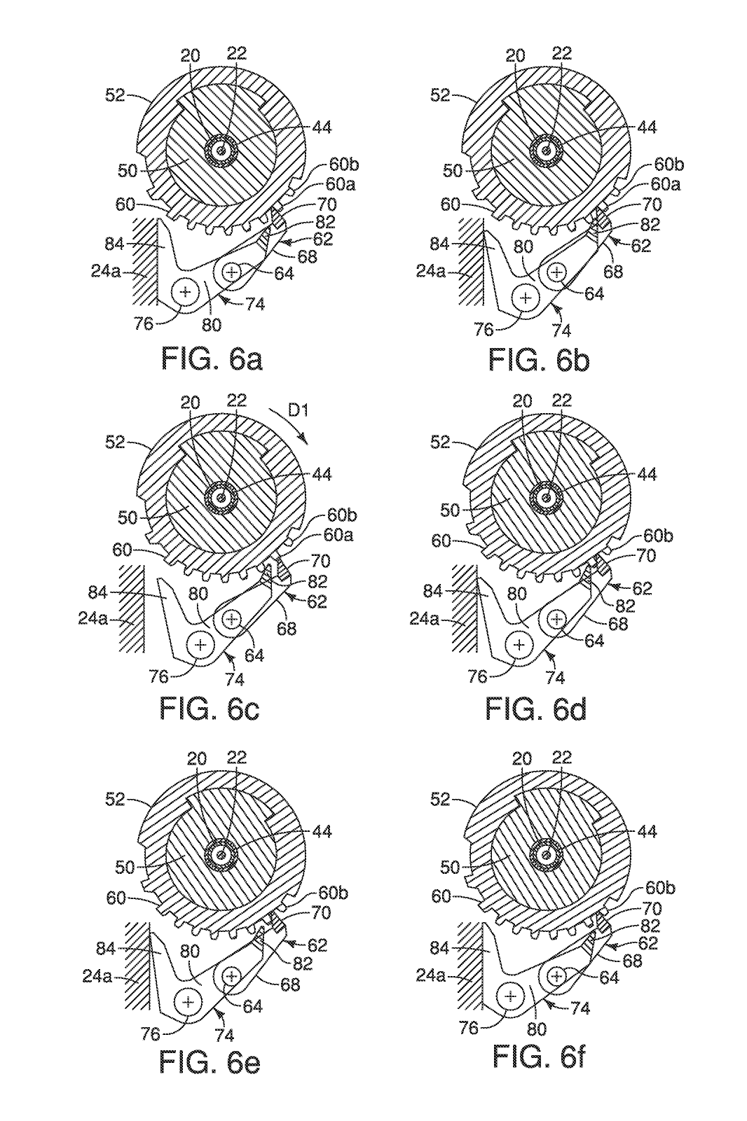

As shown in FIG. 5, in this embodiment, the cable passageway 42 extends through the movable part 48. The cable passageway 42 is defined by the hollow cable receiving shaft 44 as described above. The movable part 48 of the shifting unit 28 includes a wire take up member 50 configured to rotate about a rotational axis R and the cable passageway 42 extends along a passage axis P coaxial with the rotational axis R. Further, in this embodiment, the bracket 38 is pivotally mounted on the hollow cable receiving shaft 44 around the rotational axis R. Thus, the shift axis S_{y} of the operating member 26 is also coaxial with the rotational axis R and the passage axis P. In this embodiment, the movable part 48 of the shifting unit 28 further includes a ratchet wheel 52 fixed to the wire take up member 50 so as to rotate together with the wire take up member 50 about the rotational axis R. The shifting unit 28 further includes a holding mechanism 54 and a drive mechanism 56. The wire take up member 50 includes a groove 50a along its periphery, for windably receiving the inner cable 16 of the shift cable 12. The wire take up member 50 is biased in a first or cable-release direction D1 (FIG. 6c) by tension in the inner cable 16 and by a return spring 58. The return spring 58 operatively connects the wire take up member 50 to the base member 24.

Turning to FIGS. 6a-6f, which disclose one embodiment, the ratchet wheel 52 includes a periphery and a plurality of ratchet teeth 60 disposed about the periphery. The holding mechanism 54 includes a first or positioning pawl 62 engageable with the ratchet teeth 60 to prevent rotating or unwinding of the wire take up member 50. The ratchet wheel 52 is rotatably mounted to the hollow cable receiving shaft 44 and rotates with the wire take up member 50. The ratchet teeth 60 respectively correspond to gear positions of the shifting unit 28. Alternatively, the ratchet wheel 52 and the wire take up member 50 may be formed as a single piece. The first pawl 62 is rotatable about a first pivot 64 fixed to the base member 24 and is axially positioned by a retaining ring 66. The first pawl 62 includes a body 68 and a first nose 70 extending from the body 68. The first nose 70 is biased to engage one of the ratchet teeth 60 by a preloaded spring 72 (FIG. 5) coaxially mounted to the first pivot 64.

The shifting unit 28 includes a second or winding pawl 74 rotatably mounted about a second pivot 76 mounted to the bracket 38. The second pawl 74 is axially positioned by a retaining ring 78. The second pawl 74 includes a body 80, a second nose 82 extending from the body 80, and a tail 84. A preloaded spring 86 (FIG. 5) biases the second pawl 74 such that the second nose 82 moves toward the ratchet teeth 60 when the operating member is operated from the rest position along the shifting path S. The tail 84 of the second pawl 74 rests against a declutching element (e.g., in this embodiment, declutching wall 24a) of the base member 24, when the operating member 26 is in the rest position.

As illustrated in FIGS. 1, 3 and 4, to actuate the shifting unit 28, the operating member 26 is pivoted or rotated about the shift axis S_{y} along the shifting path S causing a first shift movement, which releases the inner cable 16 of the shift cable 12. As the shifting unit 28 is further pivoted or rotated about the shift axis S_{y} along the shifting path, a second shift movement is caused, pulling or winding the inner cable 16. The first shift movement and the second shift movement are in the same direction and the second shift movement is greater than the first shift movement. In these shift operations, the operating member 26 is moved along the shifting path S without substantially actuating or pulling the inner cable 22 of the brake cable 18.

Returning to FIGS. 6a-6f, a cable-release operation is described. Before the operating member 26 is actuated, the tail 84 of the second pawl 74 rests against the declutching wall 24a (FIG. 6a), and the operating member 26 is positioned in its rest position (FIG. 1). Further, the wire take up member 50 and the ratchet wheel 52 are retained in a selected gear position by the first pawl 62, shown engaging a corresponding first ratchet tooth 60a.

Turning to FIG. 6b, as the operating member 26 is actuated by the rider, the operating member 26 and the bracket 38 pivot about the shift axis S_{y} (FIG. 5), moving the second pawl 74 away from the declutching wall 24a and pivoting the second nose 82 toward the ratchet teeth 60. As shown in FIG. 6c, as the operating member 26 is further pivoted, the second nose 82 engages with the first nose 70, causing the first pawl 62 to release the first ratchet tooth 60a of the ratchet wheel 52. Once released, the ratchet wheel 52 rotates about the rotational axis R in the first direction D1, until the first ratchet tooth 60a engages the second nose 82. This action provides both audible and tactile feedback to the rider, signaling the rider to release the operating member 26, if a cable-release operation is desired.

Turning to FIG. 6d, as the operating member 26 is released, the operating member 26 pivots towards the rest position under the biasing force of the spring 45 (FIGS. 1 and 4), and the ratchet wheel 52 rotates in the first direction D1. Further, the first nose 70 moves toward engagement with a recess associated with an adjoining second ratchet tooth 60b of the ratchet wheel 52, and the tail 84 moves toward engagement with the declutching wall 24a. As the operating member 26 pivots further toward the rest position, the second nose 82 pivots further away from the ratchet teeth 60, due to the torque created as the tail 84 bears against the declutching wall 24a (FIG. 6e). When the drive pawl 74 disengages from the ratchet teeth 60, the ratchet wheel 52 rotates in the first direction D1 under the force of the inner cable 16 of the shift cable 12 and the return spring 58, until the first nose 70 engages the second ratchet tooth 60b, resulting in a gear shift, by one gear increment, in the first direction D1. At the end of the cable-release operation, the second pawl 74 moves back to its rest position against the declutching wall 24a (FIG. 6f), positioning the operating member 26 in the rest position.

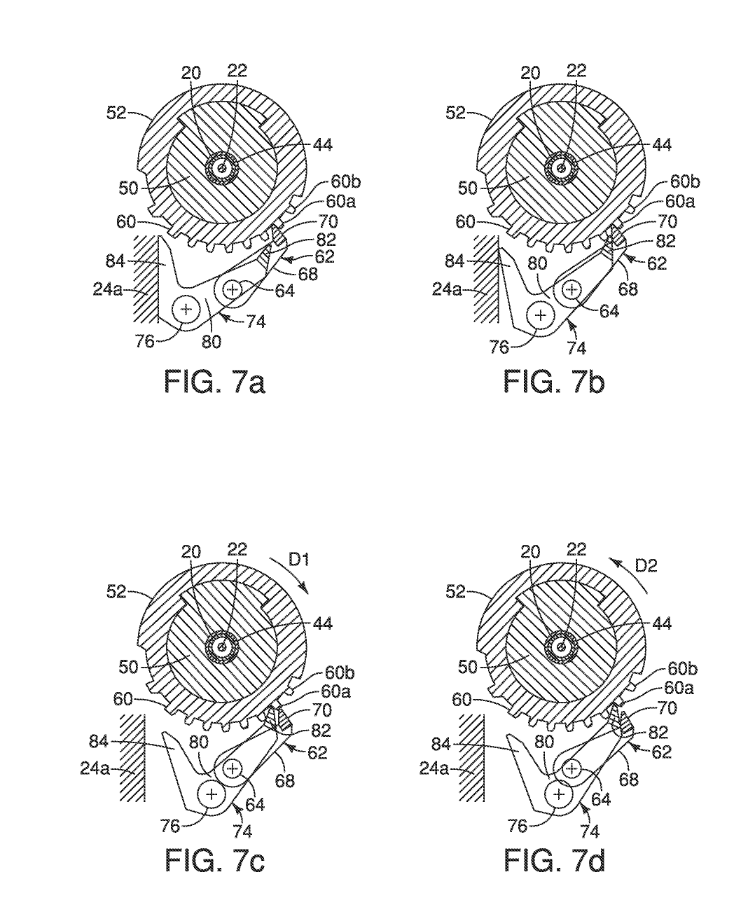

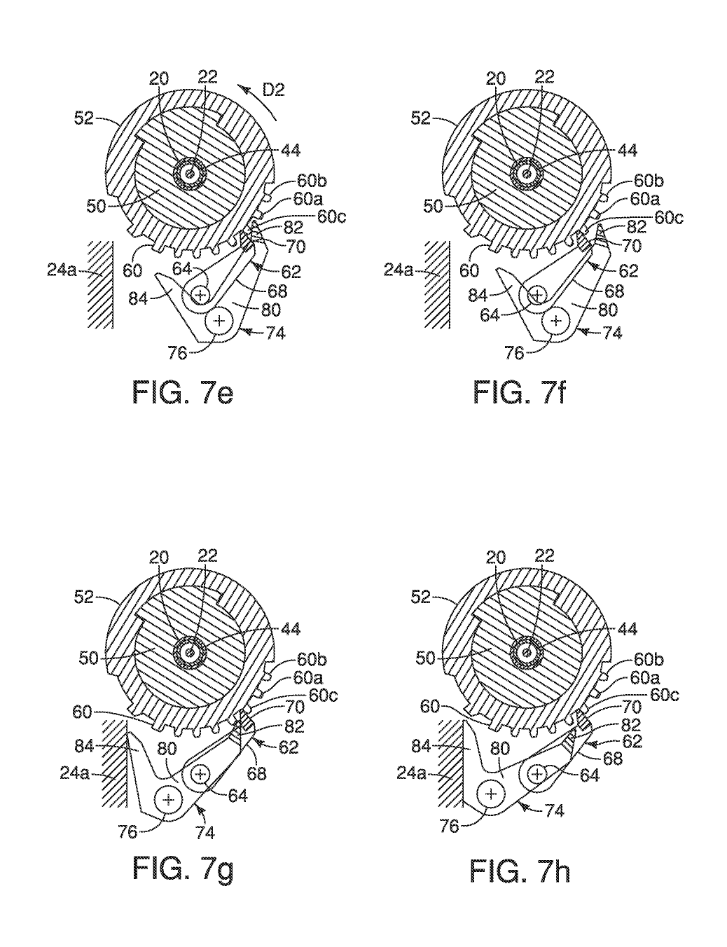

FIGS. 7a-7h illustrate one embodiment of a cable-pull operation. In this embodiment, before the operating member 26 is actuated, the tail 84 rests against the declutching wall 24a (FIG. 7a), and the operating member 26 is positioned in its rest position (FIG. 1). Further, the wire take up member 50 and the ratchet wheel 52 are retained in a selected gear position by the first pawl 62, shown engaging a corresponding first tooth 60a.

Turning to FIG. 7b, as the operating member 26 is actuated by the rider, the operating member 26 and the bracket 38 pivot about the shift axis S_{y} (FIG. 5), moving the second pawl 74 away from the declutching wall 24a and pivoting the second nose 82 toward the ratchet teeth 60. As shown in FIG. 7c, as the operating member 26 is further pivoted, the second nose 82 engages the first nose 70, driving the first nose 70 out of engagement with the first ratchet tooth 60a. Once released, the ratchet wheel 52 rotates in the first direction D1 until the first ratchet tooth 60a engages the second nose 82. As the operating member 26 is further pivoted along the shifting path S, the second pawl 74 drives the ratchet wheel 52 in the second or cable-pull direction D2 (FIG. 7d) being opposite to the first direction D1. As the first pawl 62 free-clutches, the ratchet wheel 52 freely rotates with respect to the second pawl 74 (FIG. 7d).

As shown in FIG. 7e, as the operating member 26 is further pivoted, the drive pawl 74 further rotates the ratchet wheel 52 in the second direction D2 until the holding pawl 62 engages a next third ratchet tooth 60c on the ratchet wheel 52, resulting in a single gear shift in the second direction D2. The rider may readily shift multiple gear increments in the second direction D2 by simply continuing to move the operating member 26 along the shifting path S, until the desired gear position is reached. Audible and tactile feedback is provided to the rider as each gear shift increment is passed.

As shown in FIG. 7f, after the desired gear position is reached, the rider releases the operating member 26 causing the operating member 26 and the drive pawl 74 to pivot toward their rest positions under the force of the return spring 45. As the operating member 26 further pivots toward its rest position, the tail 84 bears against the declutching wall 24a, creating a torque that pivots the drive pawl 74 away from the ratchet teeth 60 (FIG. 7g). Turning to FIG. 7h, the drive pawl 74 is in the rest position against the declutching wall 24a, with the second nose 82 disengaged from the ratchet wheel 52.

In other words, to shift the transmission device (e.g., a derailleur), as shown in FIGS. 3 and 4, the operating member 26 is configured to be moved along the shifting path S from a rest position SP₀ to a first shift position SP₁ to actuate the shifting unit 28, and is configured to be moved along the shifting path S from the rest position SP₀ to a second shift position SP₂ to actuate the shifting unit 28. The first shift position SP₁ being farther from the rest position SP₀ than the second shift position SP₂. That is, the movable part 48 including the wire take up member 50 is configured to rotate about the rotational axis R in the first direction D1 (FIG. 7c) and the second direction (FIG. 7d) opposite to the first direction D1. The shifting unit 28 is configured to rotate the wire take up member 50 in the first direction D1 as the operating member 26 is moved from the rest position SP₀ to the first shift position SP₁ and is configured to rotate wire take up member 50 in the second direction D2 as the operating member 26 is moved from the rest position SP₀ to the second shift position SP₂.

As is discussed herein, the operating member 26 is pivoted about the shift axis S_{y} along the shifting path S for a first shift movement to release the inner cable 16 of the shift cable 12, and in the same direction for a second shift movement to pull the inner cable 16, the second shift movement being greater than the first shift movement. The operating member 26 is moved along the shifting path S without pulling the inner cable 22 of the brake cable 18, since the brake cable 18 extends through the shifting unit 28. More specifically, since the brake cable 18 extends along the shift axis S_{y} in the shifting unit 28 and a position relationship or distance between the end portion 22a of the inner cable 22 and the shift axis S_{y} is unchanged, the inner cable 22 of the brake cable 18 is not pulled in the shifting operation. In other words, according to the bicycle control device 10, the shifting operation and the braking operation can be provided simultaneously.

### Second Embodiment

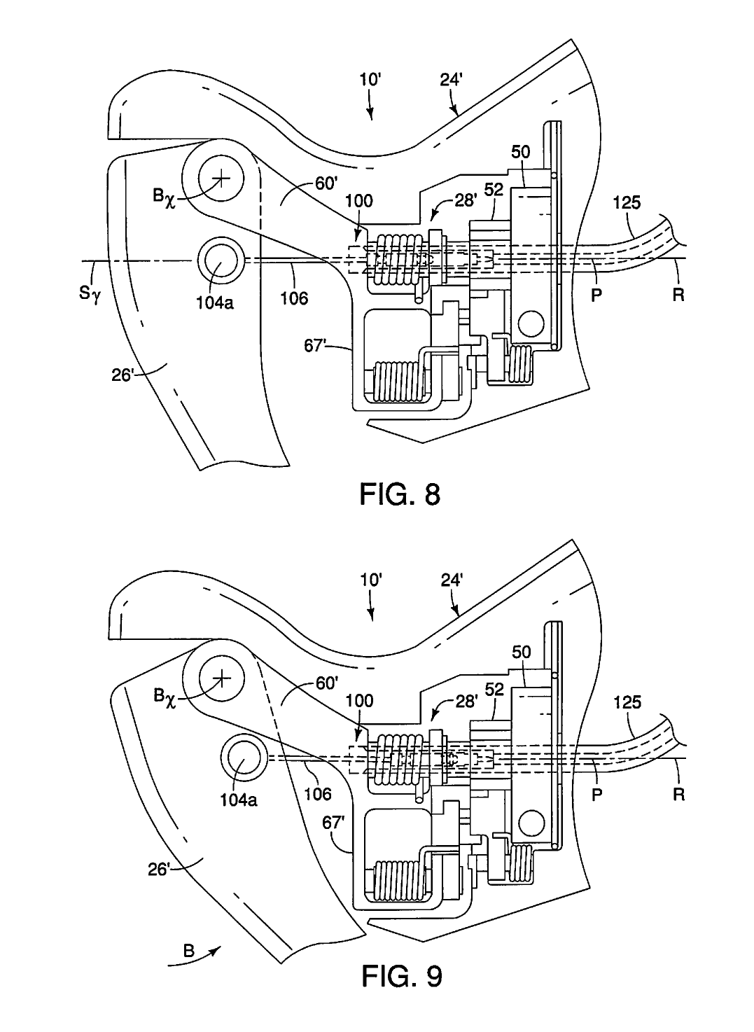

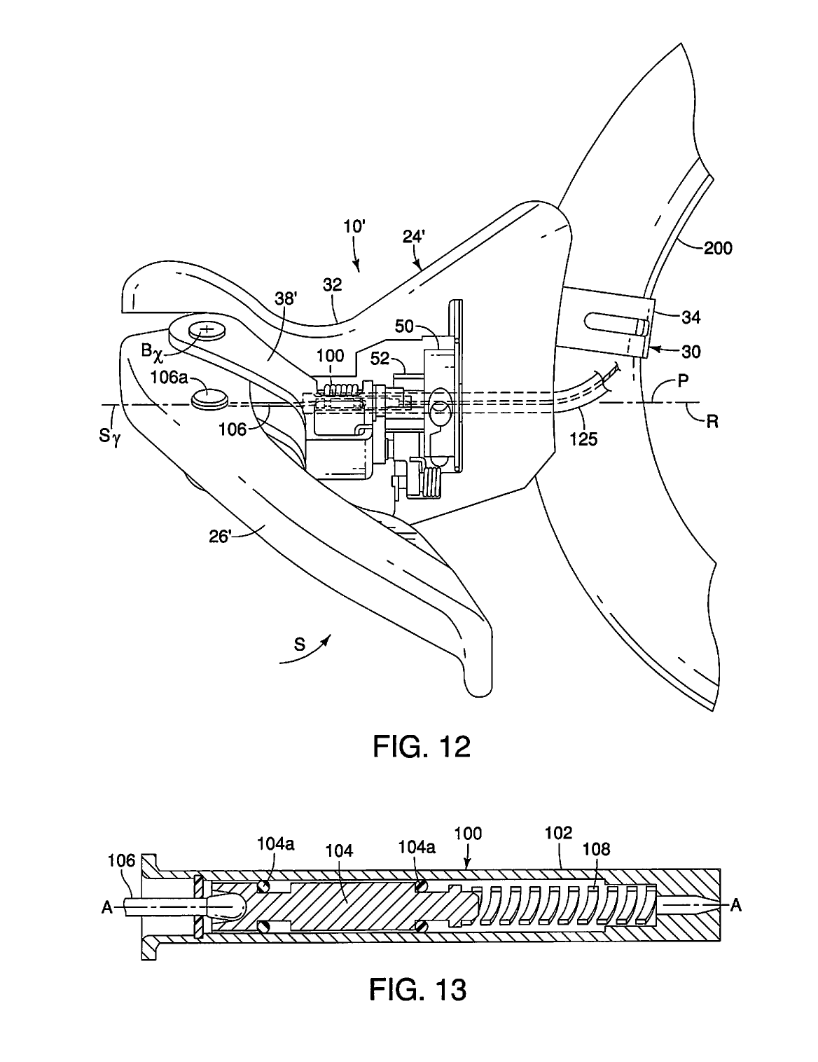

Referring now to FIGS. 8-13, a bicycle control device 10′ in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a prime (′).

The configuration of the bicycle control device 10′ in this embodiment will now be described. The bicycle control device 10′ comprises a base member 24′, an operating member 26′, a shifting unit 28′, and a hydraulic braking unit 100. The base member 24′ may be a housing that is configured to be fixed to a bicycle part, such as the handlebar 200 by the bicycle mounting structure 30.

The operating member 26′ is movably coupled relative to the base member 24′, and is configured to perform a braking operation upon being moved along a braking path B and to perform a shifting operation upon being moved along a shifting path S differing from the braking path. As illustrated in FIGS. 8-13, the shifting unit 28′ is coupled to the base member 24′, the shifting unit 28′ including a movable part 48 and a passageway 42 extending through the movable part 48. The operating member 26′ is rotatably or pivotally attached to a bracket 38′ of the shifting unit 28′ to pivot about a brake axis Bₓ to perform the braking operation upon being moved along the braking path B. The bracket 38′ is configured to pivot about a shifting axis S_{y}. Thus, the operating member 26′ attached to the bracket 38′ is further pivotally mounted to the shifting unit 28′ to pivot about a shift axis S_{y} to perform the shifting operation upon being moved along the shifting path S which differs from the braking path B. In the present embodiment, the brake axis Bₓ is substantially perpendicular to the shift axis S_{y}.

The operating member 26′ is configured to be moved along the shifting path S from a rest position SP₀ to a first shift position SP₁ to actuate the shifting unit 28′, and configured to be moved along the shifting path S from the rest position SP₀ to a second shift position SP₂ to actuate the shifting unit 28′, the first shift position SP₁ being farther from the rest position SP₀ than the second shift position SP₂. More, particularly, in one embodiment, the movable part 48 of the shifting unit 28′ includes a wire take up member 50 configured to rotate about a rotational axis R in a first direction D1 (FIG. 7c) and a second direction D2 (FIG. 7d) being opposite to the first direction. The shifting unit 28′ is configured to rotate the wire take up member 50 in the first direction D1 as the operating member 26′ is moved from the rest position SP₀ to the first shift position SP₁ and is configured to rotate wire take up member 50 in the second direction as the operating member 26′ is moved from the rest position SP₀ to the second shift position SP₂. The shifting unit 28′ may further include a ratchet wheel 52 fixed to the wire take up member 50 so as to rotate together with the wire take up member 50 about the rotational axis R.

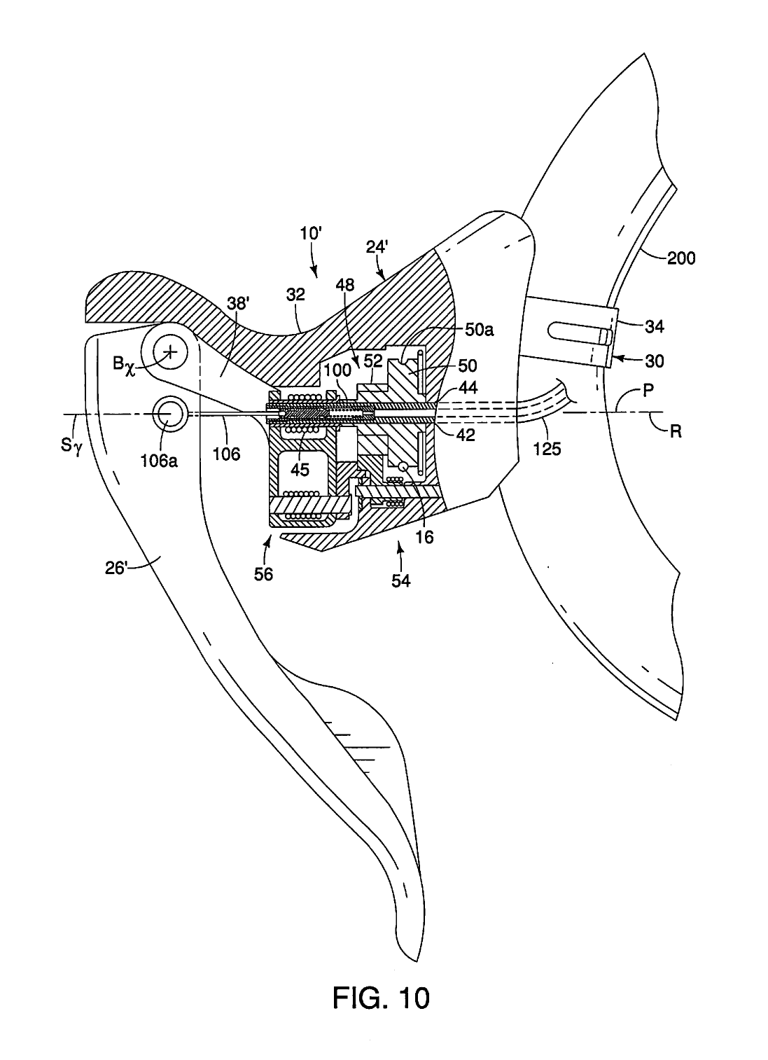

As shown in FIGS. 10, 11 and 13, the hydraulic braking unit 100 is at least partially disposed inside the passageway 42 (e.g., hollow receiving shaft 44) of the shifting unit 28′, in any suitable manner. The hydraulic braking unit includes a cylinder body 102 extending along a cylinder axis A, a piston 104 movably disposed in the cylinder body 102 and a connecting rod 106 connecting the operating member 26′ to the piston 104 at a rod end portion 106a. In one embodiment, the cylinder axis A is coaxial with the shift axis S_{y}, the rotational axis R and the passage axis P.

As best seen in FIG. 13, the piston 104 is slidably located in the cylinder body 102 to actuate the hydraulic disc or rim brake device (not shown). Preferably, the piston 104 is biased outwardly by a compression spring 108 that is disposed within the cylinder body 102 and that contacts the inner end of the piston 104. Thus, the operating member 26′ is normally biased to a non-braking position by the compression spring 108 that acts on the piston 104, which in turn acts on the connecting rod 106 that is connected to the main operating member 26′. The piston 104 preferably includes a pair of annular seal 104a such that the hydraulic fluid (mineral oil) is retained within the cylinder body 102.

Similarly to as described above, the operating member 26′ is pivotally attached to the shifting unit 28′ to pivot about a brake axis Bₓ, to perform the braking operation upon being moved along the braking path B, the operating member 26′ is further pivotally mounted to the shifting unit 28′ to pivot about a shift axis S_{y} to perform the shifting operation upon being moved along a shifting path S which differs from the braking path B.

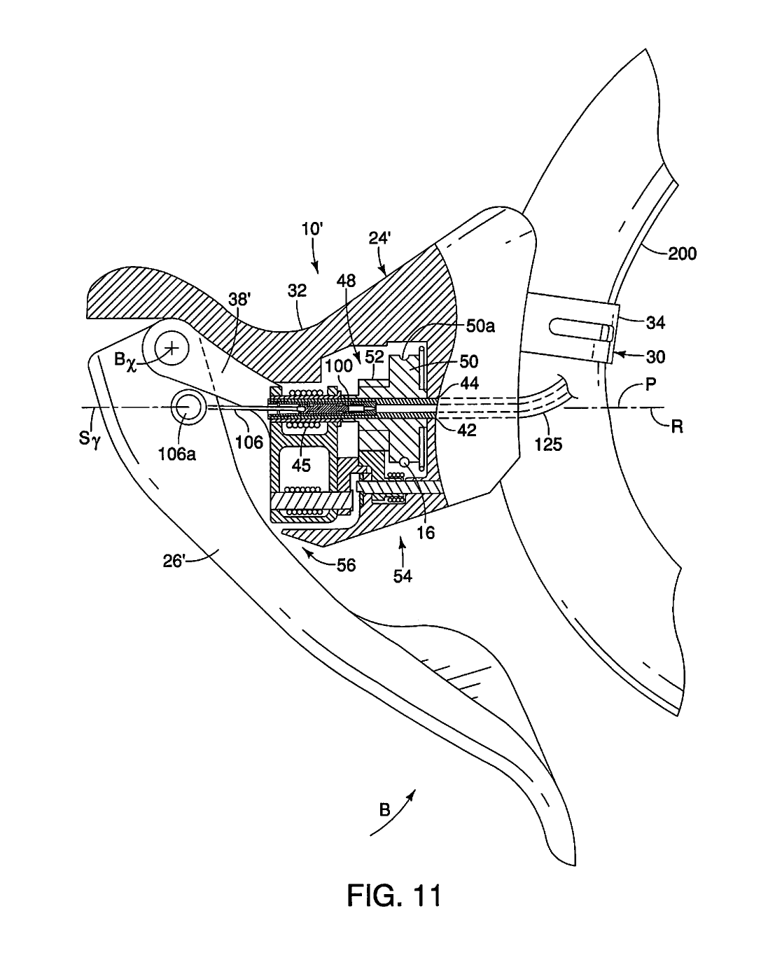

The hydraulic fluid contained in the cylinder body 102 is pressurized by movement of the piston 104 in response to the pivotal movement of the operating member 26′ towards the handlebar 200 along the braking path B. As shown in FIG. 11. The pressurized hydraulic fluid flows into a hydraulic brake hose 125 and the hydraulic brake device from the cylinder body 102 in a conventional manner.

Similarly to as the first embodiment, the operating member 26′ is moved along the shifting path S without moving the piston 104 of the hydraulic braking unit 100, since the cylinder axis A (FIG. 13) is coaxial with the shift axis S_{y}. More specifically, the cylinder body 102 and the piston 104 extends along the shift axis S_{y} in the shifting unit 28′ and a position relationship or distance between the rod end portion 106a and the shift axis S_{y} is unchanged, the piston 104 is not moved in the shifting operation. In other words, according to the bicycle control device 10′, the shifting operation and the braking operation can be provided simultaneously.

### Third Embodiment

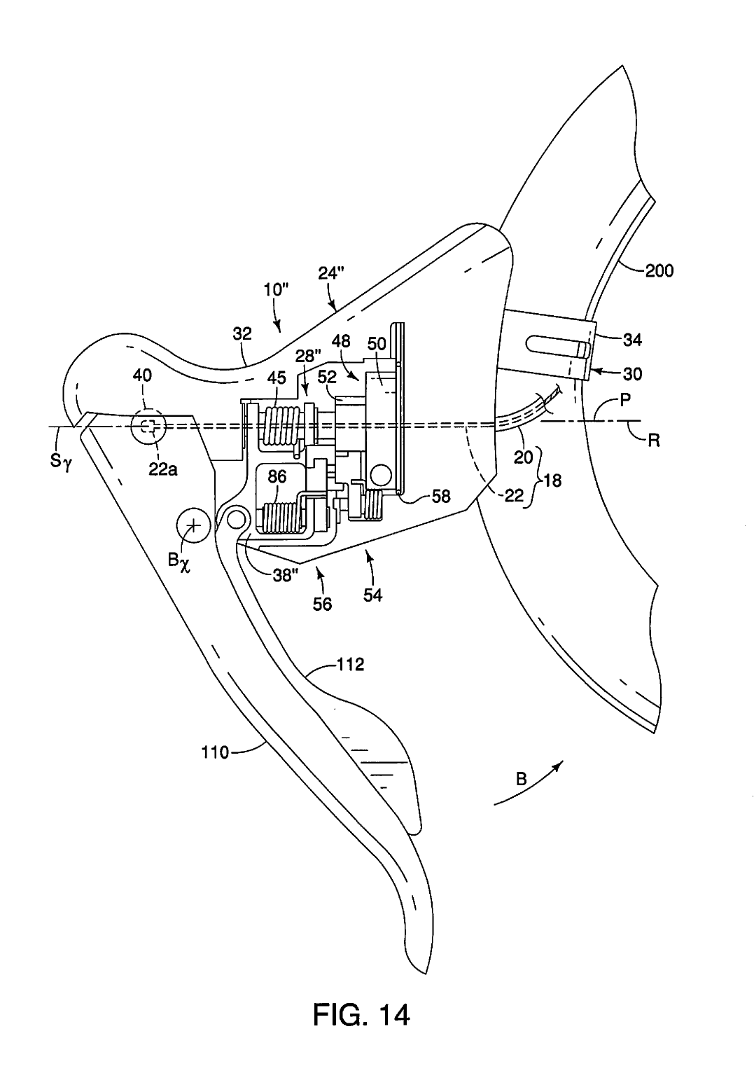

Referring now to FIGS. 14-17, a bicycle control device 10″ in accordance with a third embodiment will now be explained. In view of the similarity between the embodiments above and the third embodiment, the parts of the third embodiment that are identical to the parts of the embodiments above will be given the same reference numerals as the parts of the first embodiment. Moreover, the descriptions of the parts of the third embodiment that are identical to the parts of the embodiments above may be omitted for the sake of brevity. The parts of the third embodiment that differ from the parts of the embodiments above will be indicated with a double prime (″).

The configuration of the bicycle control device 10″ in this embodiment will now be described. The bicycle control device 10″ includes a base member 24″, a first operating member 110, a shifting unit 28″, and a second operating member 112. The base member 24″ is configured to be fixed to a bicycle part, such as the handlebar 200 by the bicycle mounting structure 30. The first operating member 110 is movably coupled relative to the base member 24″, and is configured to perform a braking operation upon being moved along a braking path B. The shifting unit 28″ is coupled to the base member 24″, the shifting unit 28″including a movable part 48 at least partially disposed within the base member 24 and a cable passageway 42 (e.g., hollow receiving shaft 44) extending through the movable part 48 (see FIG. 5).

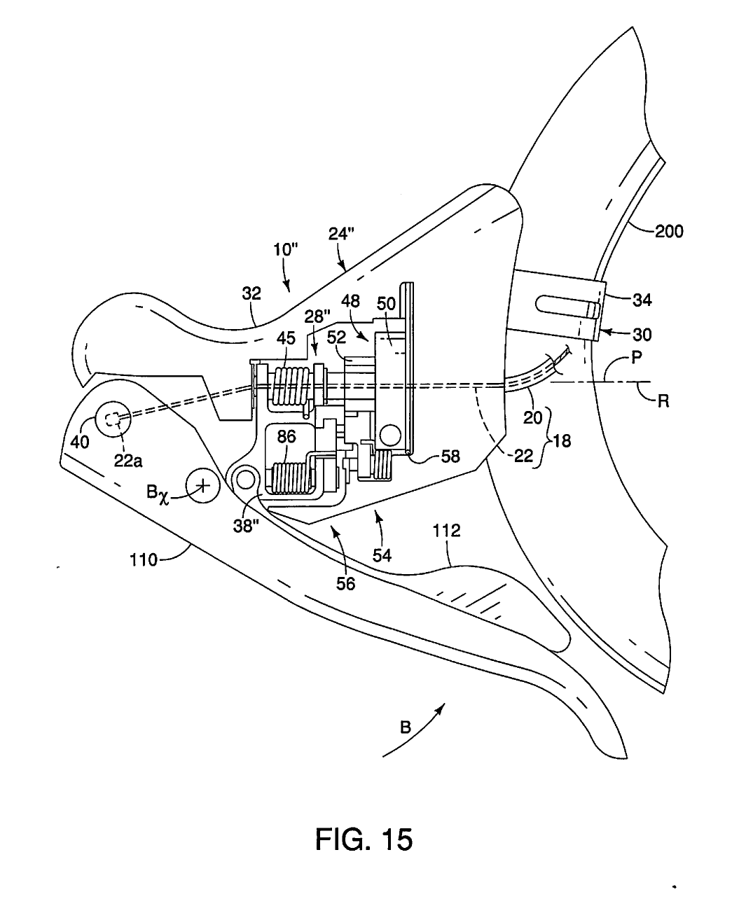

The second operating member 112 is movably coupled relative to the base member 24″ along a shifting path S differing from the braking path B. As illustrated in FIGS. 14 and 15, the second operating member 112 is coupled to a bracket 38″ of the shifting unit 28″ so as to be capable of moving along the braking path B. Although such movement may not result in an operation of the brake device (not shown) or the shifting unit 28″, this movement enables the first operating member 110 to properly move in the braking path B when operated.

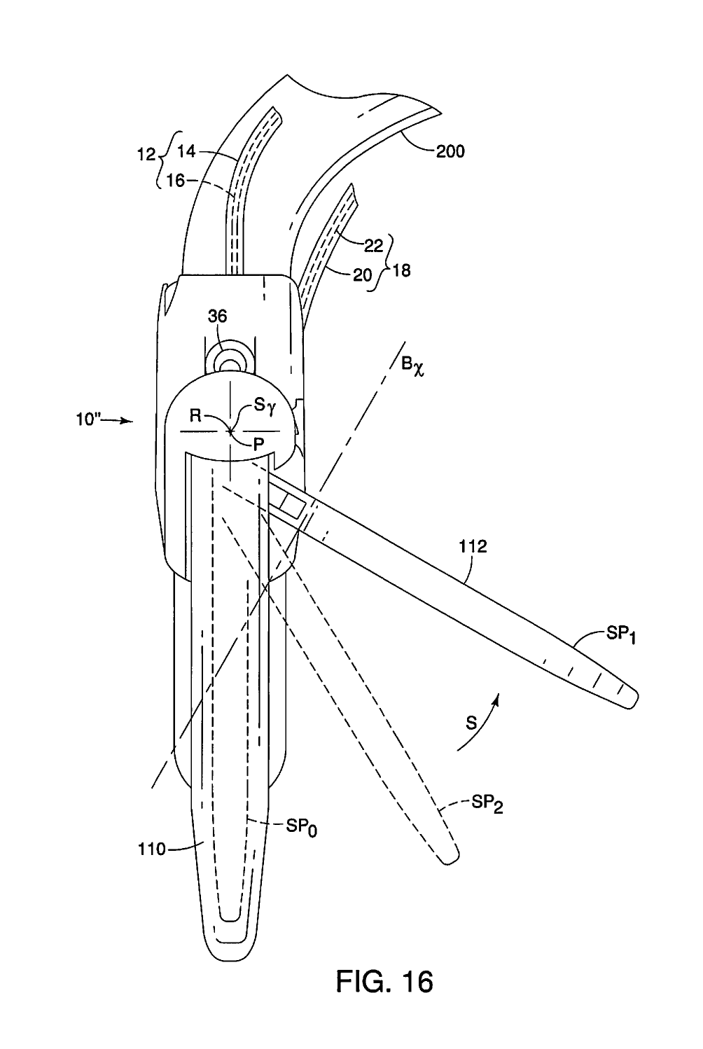

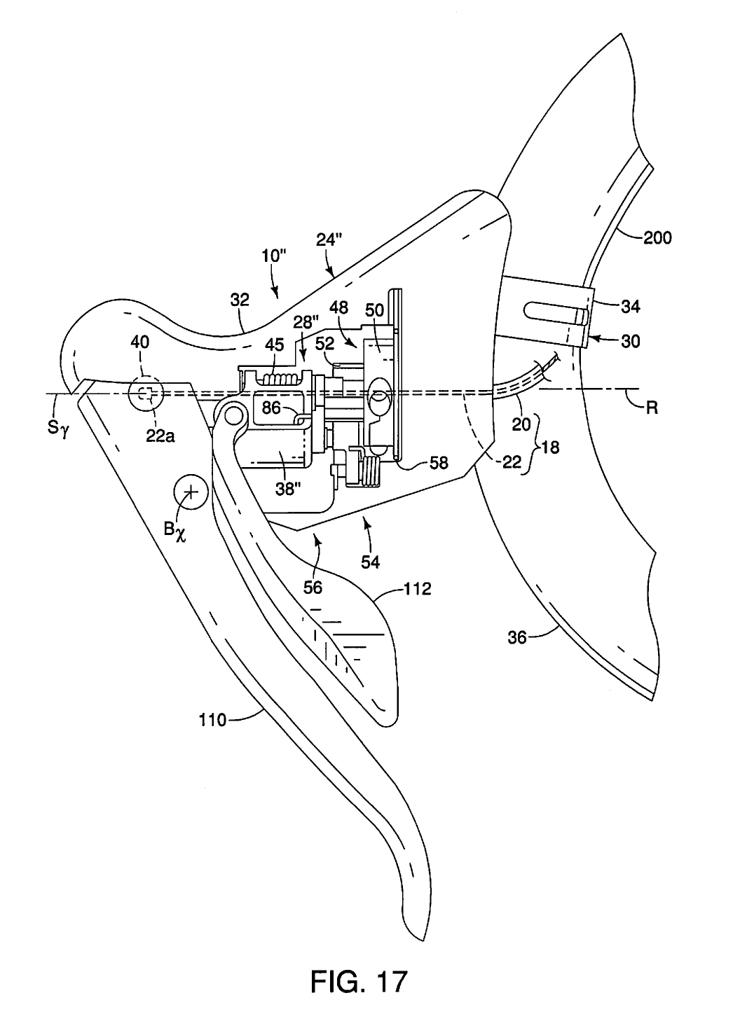

As shown in FIGS. 16 and 17, the second operating member 112 is coupled to the bracket 38″ also so as to be configured to be moved along the shifting path S from a rest position SP₀ to a first shift position SP₁ to actuate the shifting unit 28″, and is configured to be moved along the shifting path S from the rest position SP₀ to a second shift position SP₂ to actuate the shifting unit 28″, the first shift position SP₁ being farther from the rest position SP₀ than the second shift position SP₂ in a manner similar to operating member 26 discussed in the first embodiment.

As shown in FIGS. 16 and 17, movement of the second operating member 112 along the shifting path S preferably results in the movement of the moveable part 48 of the shifting unit 28″ about the shifting axis S_{y}. Further, the movable part 48 of the shifting unit 28″ may include a wire take up member 50 configured to rotate about a rotational axis R in a first direction D1 (FIG. 7c) and a second direction D2 (FIG. 7d) opposite to the first direction D1. The shifting unit 28″ is configured to rotate the wire take up member 50 in the first direction D1 as the operating member 26 is moved from the rest position SP₀ to the first shift position SP₁ and is configured to rotate the wire take up member 50 in the second direction (D2) as the operating member 26 is moved from the rest position SP₀ to the second shift position SP₂.

In a manner similar to discussed above, according to the bicycle control device 10″, the shifting operation and the braking operation can be provided simultaneously. Further, in a construction having the first or brake operating member 110 and the second or shift operating member 112, the base member 24″ can be compactly provided since the brake cable 18 extends the cable passageway 42 of the shifting unit 28″.

As used herein, the following directional terms “front, rear, above and downward” as well as any other similar directional terms refer to those directions of a device equipped with the present invention. Accordingly, these terms, as utilized to describe the present invention should be interpreted relative to a device equipped with the present invention. The terms of degree such as “substantially” and “about” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A bicycle control device comprising:
a base member configured to be fixed to a bicycle part;
an operating member movably coupled relative to the base member, and being configured to perform a braking operation upon being moved along a braking path and to perform a shifting operation upon being moved along a shifting path differing from the braking path; and
a shifting unit coupled to the base member, and being configured to be actuated in response to movement of the operating member along the shifting path, the shifting unit including a movable part at least partially disposed within the base member and a cable passageway extending through the movable part.

2. The bicycle control device according to claim 1, wherein
the movable part of the shifting unit includes a wire take up member configured to rotate about a rotational axis, and
the cable passageway extends along a passage axis coaxial with the rotational axis.

3. The bicycle control device according to claim 2, wherein
the movable part of the shifting unit further includes a ratchet wheel fixed to the wire take up member so as to rotate together with the wire take up member about the rotational axis.

4. The bicycle control device according to claim 1, wherein
the operating member is configured to be moved along the shifting path from a rest position to a first shift position to actuate the shifting unit, and is configured to be moved along the shifting path from the rest position to a second shift position to actuate the shifting unit, the first shift position being farther from the rest position than the second shift position.

5. The bicycle control device according to claim 4, wherein
the movable part of the shifting unit includes a wire take up member configured to rotate about a rotational axis in a first direction and a second direction opposite to the first direction,
the shifting unit is configured to rotate the wire take up member in the first direction as the operating member is moved from the rest position to the first shift position, and is configured to rotate the wire take up member in the second direction as the operating member is moved from the rest position to the second shift position.

6. The bicycle control device according to claim 1, wherein
the cable passageway is configured to receive an outer casing of a bowden cable.

7. The bicycle control device according to claim 1, wherein
the operating member includes a receiving portion for receiving an end portion of a brake cable which passes through the cable passageway of the shifting unit.

8. The bicycle control device according to claim 1, wherein
the operating member is pivotally attached to the shifting unit to pivot about a brake axis to perform the braking operation upon being moved along the braking path, the operating member is further pivotally mounted to the shifting unit to pivot about a shift axis to perform the shifting operation upon being moved along the shifting path.

9. The bicycle control device according to claim 8, wherein
the movable part of the shifting unit includes a wire take up member configured to rotate about a rotational axis,
the cable passageway extends along a passage axis coaxial with the rotational axis and the shift axis.

10. A bicycle control device comprising:
a base member configured to be fixed to a bicycle part;
an operating member movably coupled relative to the base member to perform a braking operation upon being moved along a braking path; and
a shifting unit coupled to the base member, the shifting unit including a movable part disposed on the base member and a cable passageway extending through the movable part, and being configured so as to receive an outer casing of a bowden cable.

11. A bicycle control device comprising:
a base member including a bicycle mounting structure and a gripping portion configured to be gripped by a rider,
an operating member movably coupled relative to the base member to perform a braking operation upon being moved along a braking path;
a shifting unit coupled to the base member, the shifting unit including a movable part and a passageway extending through the movable part; and
a hydraulic braking unit at least partially disposed inside the passageway of the shifting unit.

12. The bicycle control device according to claim 11, wherein
the movable part of the shifting unit includes a wire take up member configured to rotate about a rotational axis,
the passageway extends along a passage axis coaxial with the rotational axis.

13. The bicycle control device according to claim 12, wherein
the hydraulic braking unit includes a cylinder body extending along a cylinder axis, a piston movably disposed in the cylinder body and a connecting rod connecting the operating member to the piston.

14. The bicycle control device according to claim 13, wherein
the cylinder axis is coaxial with the rotational axis and the passage axis.

15. The bicycle control device according to claim 12, wherein
the movable part of the shifting unit further includes a ratchet wheel fixed to the wire take up member so as to rotate together with the wire take up member about the rotational axis.

16. The bicycle control device according to claim 11, wherein
the operating member is configured to be moved along a shifting path from a rest position to a first shift position to actuate the shifting unit, and configured to be moved along the shifting path from the rest position to a second shift position to actuate the shifting unit, the first shift position being farther from the rest position than the second shift position.

17. The bicycle control device according to claim 16, wherein
the movable part of the shifting unit includes a wire take up member configured to rotate about a rotational axis in a first direction and a second direction being opposite to the first direction,
the shifting unit is configured to rotate the wire take up member in the first direction as the operating member is moved from the rest position to the first shift position and is configured to rotate the wire take up member in the second direction as the operating member is moved from the rest position to the second shift position.

18. The bicycle control device according to claim 11, wherein
the operating member is pivotally attached to the shifting unit to pivot about a brake axis to perform the braking operation upon being moved along the braking path, the operating member is further pivotally mounted to the shifting unit to pivot about a shift axis to perform the shifting operation upon being moved along a shifting path which differs from the braking path.

19. The bicycle control device according to claim 18, wherein
the movable part of the shifting unit includes a wire take up member configured to rotate about a rotational axis,
the passageway extends along a passage axis coaxial with the rotational axis and the shift axis.

20. A bicycle control device comprising:
a base member configured to be fixed to a bicycle part;
a first operating member movably coupled relative to the base member, and being configured to perform a braking operation upon being moved along a braking path;
a shifting unit coupled to the base member, the shifting unit including a movable part at least partially disposed within the base member and a cable passageway extending through the movable part; and
a second operating member movably coupled relative to the base member along a shifting path differing from the braking path, the second operating member configured to be moved along the shifting path from a rest position to a first shift position to actuate the shifting unit, and being configured to be moved along the shifting path from the rest position to a second shift position to actuate the shifting unit, the first shift position being farther from the rest position than the second shift position.

21. The bicycle control device according to claim 20, wherein
the movable part of the shifting unit includes a wire take up member configured to rotate about a rotational axis in a first direction and a second direction opposite the first direction, and
the shifting unit is configured to rotate the wire take up member in the first direction as the operating member is moved from the rest position to the first shift position and is configured to rotate the wire take up member in the second direction as the operating member is moved from the rest position to the second shift position.
